(19) United States
(12) Patent Application Publication
(10) Pub. No.: US 2022/0204156 A1
(43) Pub. Date: Jun. 30, 2022

(54) SURFING ARRANGEMENT FOR MOUNTING TO AN AIRCRAFT, AND AN AIRCRAFT COMPRISING SUCH AN ARRANGEMENT

(71) Applicant: NORTHERN FLIGHT SERVICE AB, Linköping (SE)

(72) Inventor: David PAJUS, Linköping (SE)

(21) Appl. No.: 17/604,521

(22) PCT Filed: Apr. 16, 2020
(86) PCT No.: PCT/SE2020/050392

§ 371 Date: Oct. 18, 2021

(30) Foreign Application Priority Data
Apr. 17, 2019 (SE) 1950487-7

(51) Int. Cl. B64C 25/52; B64C 25/22; B64C 25/66; B64C 35/00

(52) U.S. Cl. CPC B64C 25/52; B64C 35/00; B64C 25/66; B64C 25/22

(57) ABSTRACT

The invention relates to a surfing arrangement (3) for mounting to underneath an aircraft (1), comprising at least a tank of a water collecting system (10), which arrangement (3) is configured for providing a gliding surface (7) on which said aircraft (1) may surf on water when having a moving speed higher than a predetermined value. The arrangement (3) comprises an elongated body (9), underneath which elongated body (9) the gliding surface (7) is situated, wherein the elongated body (9) is connectable to underneath an aircraft (1) by means of a linkage arm arrangement (23) arranged to a coupling element (25) configured to be coupled to the aircraft (1). The linkage arm arrangement (23) is, when the arrangement (3) is coupled to an aircraft (1), operational to vertically move the elongated body (9) between a raised position, in which raised position the gliding surface (7) is positioned above a lowermost contact point of a piece of a landing gear (5), and a lower position, in which lower position the gliding surface (7) is positioned underneath said lowermost contact point of the piece of said landing gear (5). Said movement of the elongated body (9) being selectively operational during flight of the aircraft (1). The invention further relates to an aircraft (1) comprising such a surfing arrangement (3).

### TECHNICAL FIELD

The present invention relates to a surfing arrangement for mounting to an aircraft, and an aircraft comprising such an arrangement.

### BACKGROUND ART

Aircraft having the ability to land and lift from water is well known, and such aircraft may be used for a variety of different purposes. Floats are commonly used as a means of providing floating properties to an aircraft when arranged thereto, either as landing gear, or as part of a landing gear. Such aircraft may for example be used to collect water from a body of water the plane is floating on, which water then may be used for firefighting for forest fires or similar. This is highly beneficial as an aid for forest fires as it may not be easy or even possible to reach certain burning locations in a burning forest with for example a fire truck.

Some aircraft having floats arranged underneath as their landing gear are however restricted to only be able to land on and lift off from water, which makes such aircraft limited in their usages. To use such an aircraft, a pilot may have to travel to a lake or similar where said aircraft is parked before the firefighting may commence. This is thus time consuming and the damages from a fire may risk spreading during that time.

There are also aircraft comprising floats having landing wheels arranged thereto, thus making such an aircraft a more versatile hybrid aircraft that may land and lift from both conventional landing strips and bodies of water. However, for regular flying between uses of the floats, said floats are not optimal with regards to the handling of the aircraft as they are often very large and will thus create wind resistance for the aircraft. Fuel consumption will thus be increased, and such aircraft are usually not desirable for conventional flying, and it thus not an ideal solution to provide all aircraft with such floats as a means of making them usable for occasional water related operations such as firefighting for forest fires.

### SUMMARY OF THE INVENTION

Despite prior art there is a need to develop a surfing arrangement for mounting to underneath an aircraft, which arrangement may be used to surf on a surface of water while keeping the aircraft over a predetermined moving speed. There is also a need to develop such a surfing arrangement, which may be raised and lowered during flight, so as to be movable between a surfing mode and a regular landing/take-off mode. There is further a need to develop such a surfing arrangement, which may be used to collect water from a body of water being surfed on. Even further, there is a need to develop an aircraft having such a surfing arrangement coupled thereto.

An object of the invention is thus to provide an improved surfing arrangement for mounting to underneath an aircraft, which arrangement may be used to surf on a surface of water while keeping the aircraft over a predetermined moving speed. Another object is respectively to provide such a surfing arrangement, which may be raised and lowered during flight, so as to be movable between a surfing mode and a regular landing/take-off mode. An even further object is to provide such a surfing arrangement, which may be used to collect water from a body of water being surfed on. An even further object is to provide an aircraft having such a surfing arrangement coupled thereto

According to a first aspect, a surfing arrangement for mounting to underneath an aircraft, comprising at least a tank of a water collecting system, is provided. The arrangement may be configured for providing a gliding surface on which said aircraft may surf on water when having a moving speed higher than a predetermined value and may sink in the water having a moving speed below the predetermined value. The arrangement may comprise an elongated body having a front portion and a back portion and extending there between, underneath which the gliding surface is situated. The elongated body may comprise front portion and a back portion. The elongated body may further be connectable to underneath an aircraft by means of a linkage arm arrangement, arranged to a coupling element configured to be coupled to the aircraft. The linkage arm arrangement may be, when the arrangement is coupled to an aircraft, operational to vertically move the elongated body between a raised position, in which raised position the gliding surface is positioned above a lowermost contact point of a piece of a landing gear, and a lower position, in which lower position the gliding surface is positioned underneath said lowermost contact point of the piece of said landing gear so as to perform a water collecting operation. The vertical movement of the elongated body being selectively operational during flight of the aircraft.

This has the advantage that a surfing arrangement for an aircraft is provided, which surfing arrangement may be coupled to said aircraft so as to provide the possibility to surf on surfaces such as water and snow or similar. The arrangement may, when coupled to an aircraft, be operated to move to a raised position in which the arrangement is held above contact points of said landing gear that are in abutment with an underlying surface such as a landing strip or similar when the aircraft is lifting or landing. Thus, the arrangement is not hindering such lift-off and/or landing operations when positioned in said raised position. During flight of the aircraft, the surfing arrangement may be opted to be moved down to a lower position, in which lower position the arrangement instead is positioned below said contact points, so as to provide a gliding surface underneath the landing gear and its mentioned contact points. Such an aircraft provided with such an arrangement may thus lift and land as any conventional aircraft, but may be modified during flight to be able to surf on a water surface. This may be utilized for example for water retrieval from the body of water comprising the surface being surfed on, providing water to the tank of the aircraft, which tank is comprised in a water collecting system. The tank may be arranged within a body or fuselage of the aircraft. The tank may be an external tank, arranged at the outside of the body or fuselage of the aircraft. Thus, the surfing arrangement comprising the tank of the water collecting system may be arranged at any type of aircraft. This provides the huge benefit of being able to lift an aircraft provided with the described arranged from a normal landing strip or similar, but then be able to collect water from at least one available body of water at least one time, before being able to land the aircraft at said landing strip or similar using the regular landing gear of said aircraft. This may be utilized to provide such aircraft with a means of collecting water and then dumping said water at for example a burning forest or similar. The water may be dumped through a separate dumping opening, which is connected to the tank. Alternatively, or in combination, the water may be dumped through an opening, which is used for collecting water and filling the tank during surfing a body of water. Thus, such an aircraft may be used for firefighting in various environments that may be hard to reach, but still be able to perform lift-offs and landings in conventional manner at other locations than a body of water. The water collecting operation is performed when the elongated body has been positioned underneath said lowermost contact point of the piece of said landing gear my means of the linkage arm arrangement. When performing the water collecting operation, the aircraft is surfing on a water surface of the sea, a lake or similar for collecting water in the tank. The aircraft may surf on the water by means of the gliding surface provided by the surf arrangement when having a moving speed higher than the predetermined value. However, the aircraft may sink in the water when the moving speed is below the predetermined value. The surfing effect of the elongated body will thus create a lifting force of the aircraft on the water. In addition, the airodynamic forces of the aircraft will create a lifting force of the aircraft when surfing on the water. However, since elongated body is provided without a floating body, the lifting force will cease when the moving speed of the aircraft is below the predetermined value.

Furthermore, even if the surfing arrangement is primarily provided for the herein described surfing on surfaces and not for regular landing, the surfing arrangement may also provide a safer means for emergency landing on such surfaces. If the aircraft would surf at such a surface but then decrease in speed so that it moves below the predetermined value, the aircraft would stop surfing on said surface and start to sink. However, such a manoeuvre could be used as a means to lower the speed of the aircraft in a rather safe manner, wherein such an emergency landing would be much safer than a similar landing without the surfing arrangement coupled to the aircraft. Thus, emergency landings on surfaces such as water and snow is an added benefit of the arrangement, wherein the operational movement of the surfing arrangement provides a pilot of such an aircraft with additional options in the case on an emergency.

According to an aspect, the coupling element may be configured to be coupled to the landing gear of an aircraft.

This has the advantage that the surfing arrangement may be coupled to a part of an aircraft that is as close as possible to the intended plane in which the gliding surface is to used. The surfing arrangement may thus be made more compact with lesser material and parts needed to achieve the intended functionality, which saves weight for the completed arrangement. Furthermore, as landing gear of an aircraft is designed on its own to be able to handle the impacts and loads that arise when an aircraft abuts an underlying surface as for a landing operation for example, the surfing arrangement may utilize the existing strengths and benefits of such a landing gear when the gliding surface comes in abutment with a surface of water.

According to an aspect, the front portion of the elongated body may comprise a keel-shaped gliding surface, and the back portion of the elongated body may comprise a ski-shaped gliding surface.

This has the advantage that the keel-shaped front portion provides a reliable means of approaching a surface such as water, wherein the keel-shape in the same manner as for a boat mat brake waves of said surface and thus allow the arrangement to be used on surfaces of water even if there are waves present in the body of water the surface is a part of. The ski-shaped back-portion provides more stability to the arrangement in its entirety, and thus provides benefits to the construction as a whole. Thus, the front portion of the gliding surface of the elongated body may comprise the keel-shaped gliding surface, and the back portion of the gliding surface of the elongated body may comprise a ski-shaped gliding surface.

According to an aspect, the linkage arm arrangement may comprise a first and a second link arm members, pivotally coupled to the elongated body at a distance from each other at first end sections thereof, wherein the first link arm member may be pivotally coupled to a fixed position of the coupling element, and the second link arm member may be pivotally coupled to an actuator, which actuator is pivotally coupled to the coupling element.

This has the advantage that the surfing arrangement may be moved between its upper and lower positioning by means of a rotational movement about the fixed position at the coupling element, wherein the actuator provides said rotational movement by means of a single motion, making the linkage arm arrangement be simply yet effective and precise in its functionality.

According to an aspect, the gliding surface may further comprise a hatch device, selectively movable between a closed state, in which it sits flush with the gliding surface, and an open state, in which an opening is provided in the gliding surface. The opening may further be in fluid communication with a channel, which channel is configured to be coupled to the water collecting system of the aircraft.

This has the advantage that parts of a water collecting system may be directly incorporated in the surfing arrangement, wherein the hatch device is positioned in an ideal location to collect water. As the hatch is positioned directly at the gliding surface, the hatch is thus similarly in direct contact with the water that is to be collected, which provides a very efficient means of guiding said water into the hatch, which corresponds to an inlet port of said water collecting system. As the aircraft is moving at a speed above the predetermined level, and that the aircraft and the surfing arrangement provides a pressure towards the water surface, the water may be forced into the opening of the gliding surface purely by the movement of the aircraft, wherein no additional devices such as pumps or similar is needed to perform such a task.

The opening in the gliding surface may be provided without the hatch device. The opening may be in fluid communication with the channel coupled to the water collecting system. A valve arranged on or in the channel may be controllable for opening and closing the communication between the opening and the tank. During a water collecting operation, the valve is open. After the water collecting operation has been finished, the valve is closed in order to prevent water to flow out of the tank. However, the valve may be opened during dumping the water for fire fighting a burning forest or similar.

According to an aspect, the hatch device may further comprise sidewalls that extend from the hatch so as to cover sides areas of an open space defined by the hatch and the gliding surface whenever the hatch is not in its closed state.

This has the advantage that the hatch device will act as a funnel as soon as it is not in its closed state. This may further enhance the water collecting functionality of said hatch device.

According to an aspect, the sidewalls may further comprise flanges, arranged at edges of said sidewalls, said edges being situated flush with the gliding surface when the hatch device is in its closed state.

This has the advantage that said flanges will, when the hatch device is opened, be positioned in such a manner that water may be pushed towards them, which assists in closing the hatch device if for example a failure thereof occurs.

According to an aspect, the hatch device may be pivotally coupled to the gliding surface at a position of the hatch device, which position is situated towards the front portion of the elongated body with respect to the hatch.

This has the advantage that the hatch device will automatically be pushed towards its closed state if any part of the devices/machinery holding it open should fail. This in turn provides a safer arrangement to use in combination with water contact, as an open hatch device could act as a dragging/braking means for the aircraft, which could potentially cause issues with speed and eventual lift-off from a water surface.

According to an aspect, the hatch device may further comprise a grating, extending from an inner surface of said hatch, wherein said grating is configured to cover the opening in the gliding surface when the hatch is in its open state.

This has the advantage that said grating may function as a strainer covering the opening, which lowers the amount of debris and similar floating on the surface of the water to be able to enter the opening and parts of the water collecting system.

According to an aspect, the surfing arrangement may further comprise a hydraulic system, wherein selective vertical movement of the elongated body may be achieved by means of hydraulics.

This has the advantage that the movement of the surfing arrangement may be operated with high accuracy and be able to withstand the large forces acting thereon when the gliding surface is pressed hard towards a water surface. This in turn provides a reliable and safe surfing arrangement.

According to an aspect, the hatch device is selectively operational by means of the hydraulic system.

This has the advantage that the hatch device may be operated using a very robust and reliable technology, being able to withstand and work against the at times large forces related to a body of water exhibiting rough conditions such as waves or similar.

According to an aspect, an aircraft comprising a body, wings, landing gear and at least a tank of a water collecting system is provided. The aircraft may further comprise at least one surfing arrangement according to the disclosure, which surfing arrangement is coupled to the landing gear of said aircraft.

This has the advantage that an aircraft is provided, which aircraft may be used for collecting water from bodies of water in a very efficient manner, without hindering said aircraft to function as a conventional aircraft between such water collecting operations. The aircraft may be any kind of aircraft. A pilot within the aircraft may control the aircraft. The aircraft may be a drone, without an onboard crew. The drone may be autonomously controlled.

### BRIEF DESCRIPTION OF THE DRAWINGS

Below is a description of, as examples, embodiments with reference to the enclosed drawings, in which:

FIG. 1 shows a schematic illustration of an aircraft, with a surfing arrangement coupled thereto, in a perspective view according an embodiment,

FIGS. 2a-b show a surfing arrangement coupled to a landing gear in side views according to an embodiment, and

FIGS. 3a-b show a close up of a hatch device comprised in a surfing arrangement in a side view and a front view respectively according to an embodiment.

### DETAILED DESCRIPTION

The description of the various features, and modifications thereof, according to the disclosure will herein be described in more detail. It is thus to be understood that embodiments comprising any of the described feature or a combination of features may be assembled in accordance with the description herein.

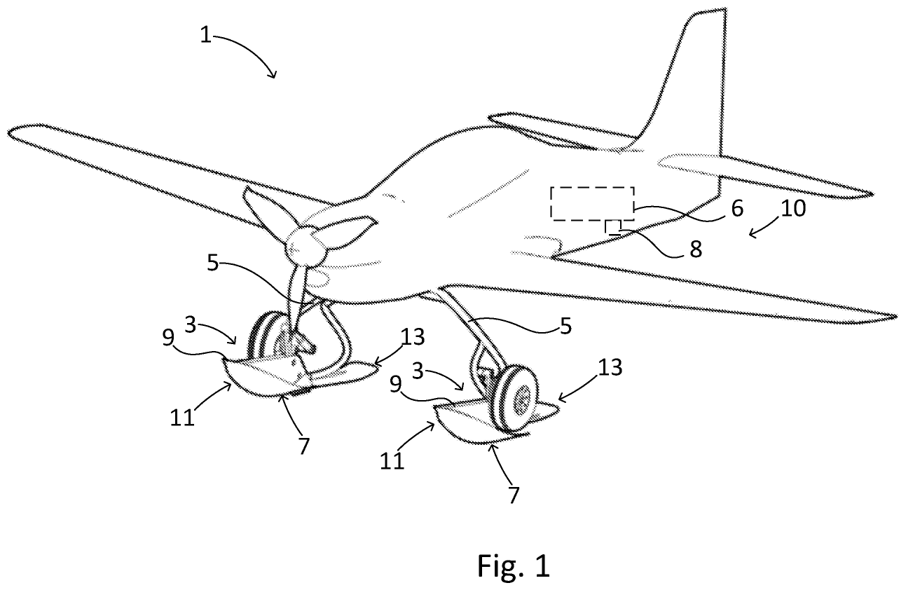

FIG. 1 shows a schematic illustration of an aircraft 1, with a surfing arrangement 3 coupled thereto, in a perspective view. As should be understood, FIG. 1 is not meant to show the details of the mentioned surfing arrangement 3 coupled to said aircraft 1, but is primarily for illustrating the concept of said arrangement 3 when used for such an aircraft 1. The aircraft 1 depicted herein may comprise a body, wings, landing gear 5 and at least a tank 6 of a water collecting system 10. The aircraft 1 may then further comprise a surfing arrangement 3 coupled to underneath said aircraft 1. The tank 6 may be arranged in the aircraft 1 or at the outside of the aircraft 1 connected to the body of the aircraft 1. The tank may be arranged with a dumping opening 8.

The surfing arrangement 3 is intended for to underneath an aircraft 1, as shown in FIG. 1. The surfing arrangement 3 may be coupled to any aircraft 1 of suitable size and model, but some features of the surfing arrangement 3 requires certain types of aircraft 1 comprising specific features of its own to be fully utilized. As will be thoroughly explained throughout the disclosure, the surfing arrangement 3 may be used for increasing efficiency and versatility when collecting water from a body of water of some sort. Thus, the aircraft 1 may be perceived to, for being able to fully utilize said functionality, to comprise at least a tank of a water collecting system 10.

The surfing arrangement 3 may be coupled to an aircraft 1 in a plurality of ways, which may be utilized differently for different modes and types of aircraft 1. The surfing arrangement may for example be mounted directly to the hull of the aircraft 1, wherein the coupling element simply may be designed as a metal plate conforming to the shape of said hull, wherein said hull and coupling element may be coupled to each other in any manner of fastening methods.

The surfing arrangement 3 may be coupled to the aircraft 1 by means of coupling the arrangement 3 to the landing gear 5 of the aircraft 1, which results in a more compact surfing arrangement 3 having a lower total weight as the link arm arrangement 23 naturally may be manufactured with shorter components to be able to perform the same functions. This will be shown as the main example of the surfing arrangement 3 throughout the disclosure for the sake of simplicity.

The surfing arrangement 3 may be configured for providing a gliding surface 7 on which said aircraft 1 may surf on water when having a moving speed higher than a predetermined value. It should herein be realized that the term surfing in this context is to be viewed as separate from landing on water, as the surfing arrangement 3 is not primarily intended for landing. The surfing arrangement 3 is instead configured for acting as a contact surface with water, wherein if as stated the aircraft 1 is moving at a speed higher than a predetermined value the aircraft 1 may surf or glide on said surface, by means of the speed of the aircraft 1 and the contact with the surface of water combined will act as a surfing motion over said water without the aircraft 1 sinking. If the aircraft 1 would lower its speed below the predetermined value, the aircraft 1 would eventually sink in the water. The predetermined value may vary depending on different characteristics of the aircraft 1 and the surfing arrangement 3, such as sizes and weights thereof, wherein the surfing arrangement 3 of course may be modified in size and/or design to be accommodated to fit to different types and sizes of aircraft 1. The surfing arrangement 3 is thus not designed to provide the ability to fully land on water, but it may also provide much safer emergency landings on water as an aircraft 1 provided with a surfing arrangement 3 according to the disclosure may be used to initially surf on a surface of water, wherein the speed of the aircraft then may be lowered to have the aircraft 1 then stopping and sinking in a much more controlled fashion compared to a head on crash-landing in water without such an arrangement 3 coupled to the aircraft 1.

The surfing arrangement 3 is thus primarily intended to be used in combination with an aircraft 1 comprising at least a tank 6 of a water collecting system 10, wherein such an aircraft 1 may surf on water, activate said water collecting system 10 so as to collect an amount of water, and then increase its speed and lift from the water to transport it to a separate location. As should be understood, such an aircraft 1 may thus be suitable to use for extinguishing forest fires or similar, by means of dumping said water on such a fire.

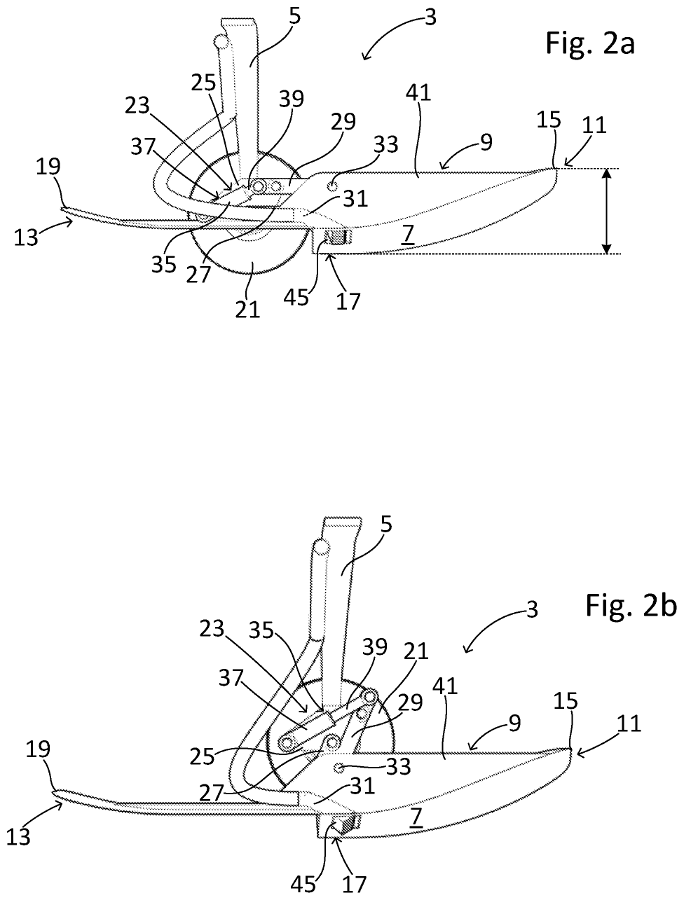

The arrangement 3 may comprises an elongated body 9 having a front portion 11 and a back portion 13 and extending there between, underneath which elongated body 9 the previously mentioned gliding surface 7 is situated. The elongated body 9 may be connectable to a landing gear 5 of an aircraft by means of a linkage arm arrangement (shown in more detail in FIGS. 2a and 2b) arranged to a coupling element configured to be coupled to said landing gear 5. The linkage arm arrangement may further be, when the arrangement is coupled to a piece of a landing gear 5, operational to vertically move the elongated body between a raised position, in which raised position the gliding surface 7 is positioned above a lowermost contact point of a piece of said landing gear 5, and a lower position, in which lower position the gliding surface 7 is positioned underneath said lowermost contact point of the piece of said landing gear 5. The term contact point is herein to be understood as the point of contact between the tire of the landing gear 5, when the aircraft 1 is stationary or in motion on a solid underlying surface such as a landing strip of an airport or similar. Again, the size and design of the surfing arrangement 3 may of course be modified so as to fit to various sizes of tires for various sizes and models of aircraft 1. Consequently, when the surfing arrangement 3 is in its raised position, the aircraft 1 is able to land and lift-off in a normal fashion, as the elongated body 9 then is raised above the contact points of the landing gear. Furthermore, the movement of the elongated body 9 may be selectively operational during flight of the aircraft. An aircraft 1 provided with a surfing arrangement 3 according to the disclosure may thus lift from a normal airport or similar, lower the surfing arrangement 3 so as to perform a water collecting operation, and then when any such water collecting and/or dumping of said water is completed, the aircraft 1 may raise up the surfing arrangement 3 and land at any suitable landing strip as if no surfing arrangement was attached to said aircraft 1. As should be obvious, this provides huge benefits for this types of operations as the versatility of an aircraft 1 provided with such a surfing arrangement 3 is hugely increased over for example an aircraft comprising floats, wherein such aircraft must land on and lift-off from water. Furthermore, the surfing arrangement 3 is smaller and lighter compared to such mentioned floats, wherein an aircraft comprising a surfing arrangement 3 instead of floats will have better aerodynamics for flight, and a better fuel efficiency due to less drag in the air.

From here on out specific details and features of the surfing arrangement 3 will be described in more detail with reference to the following figures.

FIGS. 2a-b show a surfing arrangement 3 coupled to a landing gear 5 in side views according to an embodiment. The surfing arrangement 3 according to FIGS. 2a and 2b may be perceived as the same surfing arrangement 3, wherein FIG. 2a depicts the surfing arrangement 3 being in its raised position, and FIG. 2b depicts the same surfing arrangement 3 being in its lower position.

The surfing arrangement 3 may, as is exemplified in FIGS. 2a and 2b, comprise a shape in which the front portion 11 of the elongated body 9 may comprise a keel-shaped gliding surface 7, and wherein the back portion 13 of the elongated body 9 may comprise a ski-shaped gliding surface 7. Such a keel-shaped front portion 11 and gliding surface 7 thereof provides a reliable type of design to approach and stay in contact with a surface of water while moving forward thereon. A front tip 15 of the front portion 11 and thus also the gliding surface 7 being situated furthest in the moving direction of an aircraft 1 is elevated with respect to a lowermost portion 17 of the gliding surface 7, so as to hold the front of the surfing arrangement 3 reliably above the surface and thus avoid the arrangement 3 in its entirety to be submerged under the surface which could prove dangerous as the aircraft 1 could sink if that occurred. The keel-shape as depicted in FIGS. 2a-2b is shown to have a somewhat rounded and upwards tilted extension, so as to provide an angle of attack for the gliding surface 7 with respect to a water surface that pushes the aircraft 1 upwards to some extend when said angled surface is moved forward through water when the speed of the aircraft 1 is above the predetermined value. The keel-shape furthermore provides a means of breaking potential waves of the surface of water, making the surfing arrangement 3 usable for a wider range of weather conditions. The back portion 13 of the surfing arrangement 3 does not need to break waves nor push the aircraft 1 upwards to the same extent as the front portion 11 and its comprised gliding surface 7. The back portion 13 may thus comprise, as stated and depicted herein, a ski-shaped design. The gliding surface 7 of the back portion 13 is thus more horizontally level, but may also comprise various minor design variations, such as a slightly upwards directed tail section 19 as shown in FIGS. 2a-2b. The back portion 13 and its portion of the gliding surface 7 may thus assist in providing an overall surface area for being in contact with a water surface which, as should be understood, is part of affecting the value/size of the predetermined value, which predetermined value needs to be exceeded to achieve and maintain a surfing motion of the aircraft 1 on water. The larger the total size of the gliding surface 7, the lower the predetermined speed may be while still being able to perform said surfing motion.

As is seen in FIG. 2a specifically, the surfing arrangement 3 may preferably be positioned at least in the vicinity of having a tire 21 of the landing gear 5 in the middle of the elongated body 9. Such a design and coupling provides an in general stable connection of the landing gear 5 and the elongated body 9, wherein the weight of the aircraft 1 is distributed over the gliding surface 7 in a balanced manner. Furthermore, the surfing arrangement 3 may be designed to be horizontally rigid when fully lowered as in FIG. 2b, wherein horizontally is to be viewed as in relation to the aircraft 1 when in its correct angle for flying/surfing on a surface of water. In other words, the elongated body 9 is to be perceived as being held rigidly in its positioning relative the landing gear 5, wherein angular displacement from a plane parallel with a surface of water, when the aircraft 1 is align in its correct position to surf, are kept to a minimum. This in turn means that if the pilot of the aircraft 1 makes slight unconscious adjustments to the alignment the aircraft 1 when surfing on a surface of water, the rigid elongated body 9 will hinder any larger vertical movements. If smaller rotational and/or vertical movement occur at the front or back portions 11, 13 of the elongated body 9, the rigid positioning of the surfing arrangement 3 will then instead re-align the aircraft 1 due to the forces from the water acting on the said portions 11, 13 of the elongated body 9, which will want to pivot about the landing gear 5.

As previously described, the difference between FIGS. 2a and 2b is that the elongated body 9 of the surfing arrangement 3 is positioned in the raised and the lower position respectively. This is performed and achieved by means of the linkage arm arrangement 23 that is coupled to the coupling element 25, which in turn is configured to be mounted to the landing gear 5 as depicted herein. The linkage arm arrangement 23 may comprise a first and a second link arm member 27, 29, pivotally coupled to the elongated body 9 at a distance from each other at first end sections 31, 33 thereof. The first link arm member 27 may be pivotally coupled to a fixed position of the coupling element 25, and the second link arm member 29 may be pivotally coupled to an actuator 35, which actuator 35 is pivotally coupled to the coupling element 25. The second arm member 29 may then further be coupled to another fixed position of the coupling element 25, which another fixed position is situated between the connecting points of the second arm member 29 and the elongated body 9 and the actuator 35 respectively. The actuator 35 may thus pivot the second arm member 29 about said another fixed position when activated.

Such a configuration will thus allow the elongated body 9 and the linkage arm arrangement 23 to pivot about a rotational axis aligned with the fixed position at which the first arm member 27 and the coupling element 25 are pivotally coupled to each other. At the same time, the second arm member 27 may be pivotally coupled to the elongated body 9 and the actuator 35, wherein the actuator 35 in turn is coupled to the coupling element 25. This allows for the mentioned pivoting of the arrangement to be performed while still having the elongated body 9 horizontally oriented during said pivoting. The elongated body 9 will thus not be rotated in a manner that could increase wind resistance during flight of the aircraft 1, which of course is beneficial for the aircraft 1 and manoeuvring thereof.

The above-mentioned actuator 35 may be provided to the surfing arrangement 3 using a variety of known operational actuators. The surfing arrangement 3 may further comprise a hydraulic system, wherein vertical movement of the elongated body 9 may be selectively operational by means of said hydraulic system. For such a case, which also is depicted in FIGS. 2a-2b, the actuator 35 may be a hydraulic cylinder 37 and piston 39, wherein the selective operation of the vertical movement of the elongated body 9 is achieved by means of a stroke of the piston 39 of the hydraulic cylinder 37. As is seen in FIGS. 2a-2b, the piston 39 is in its zero stroke position in FIG. 2a, and in its full stroke position in FIG. 2b. This means that if the hydraulic pressure therein would drop for some reason, the surfing arrangement 3 is automatically configured to position the elongated body 9 in its raised position, wherein normal landing and lift-off never may be impaired for such a reason. The hydraulic system, which is not shown herein in its entirety with regards to additional components such as pumps and valves, may thus be arranged and positioned at other locations of the aircraft 1. If the aircraft 1 comprises a hydraulic system of its own, the surfing arrangement 3 may of course be incorporated therein, wherein the hydraulics of the aircraft 1 may be coupled to the hydraulic system of the surfing arrangement 3.

The coupling element 25 may be perceived as a plate member comprising through-holes therein for coupling to the actuator 35, the first arm member 27, and to the landing gear 5. Such a plate member may suitably be comprised of a rigid and hard material such as metal, and should be fixedly connected to the landing gear 5 as a means of coupling the surfing arrangement in its entirety to said landing gear 5.

It may also be observed when viewing FIGS. 2a and 2b that the arm members 27, 29 of the linkage arm arrangement 23 may be coupled to a protruding flange-like element 41, protruding upwards from the elongated body 9. Such an element 41 provides both easy to access coupling positions for the link arm members 27, 29, while at the same time providing an increased stability to the elongated body 9. The protruding elements 41 may be utilized even further to act as sideways abutment surfaces for the tire 21 of the landing gear 5 when the elongated body 9 is lowered to its lower position. Such an adjacent positioning of the elongated body 9 and the upwards extending protruding elements 41 may aid in the horizontal stability of the elongated body 9 when surfing on a surface of water. As the tire 21 of the landing gear 5 is positioned behind said protruding elements 41 in FIGS. 2a and 2b, it may be difficult to visualize the interacting positioning of the tire 21 and the elongated body 9 fully. It should thus be mentioned that the surfing arrangement 3 preferably is arranged in such a manner that the tire 21 will engage the elongated body 9 during lowering thereof, and then roll on an upper surface 43 of a sideways projection of the elongated body 9. This may be seen when viewing the aircraft depicted in FIG. 1. When the elongated body 9 is fully lowered to its lower position, the abutment surfaces of the landing gear 5 and the elongated body 9 are to be viewed as fully engaged with each other, wherein the tire 21 of the landing gear is resting fully on top of the elongated body 9. For such a configuration, any forces and/or impacts acting on the gliding surface 7 of the elongated body 9 will be directly translated upwards to the landing gear 5 and any existing suspension device thereof, providing a smooth and enjoyable experience for people in an aircraft 1 surfing on water using such a surfing arrangement 3.

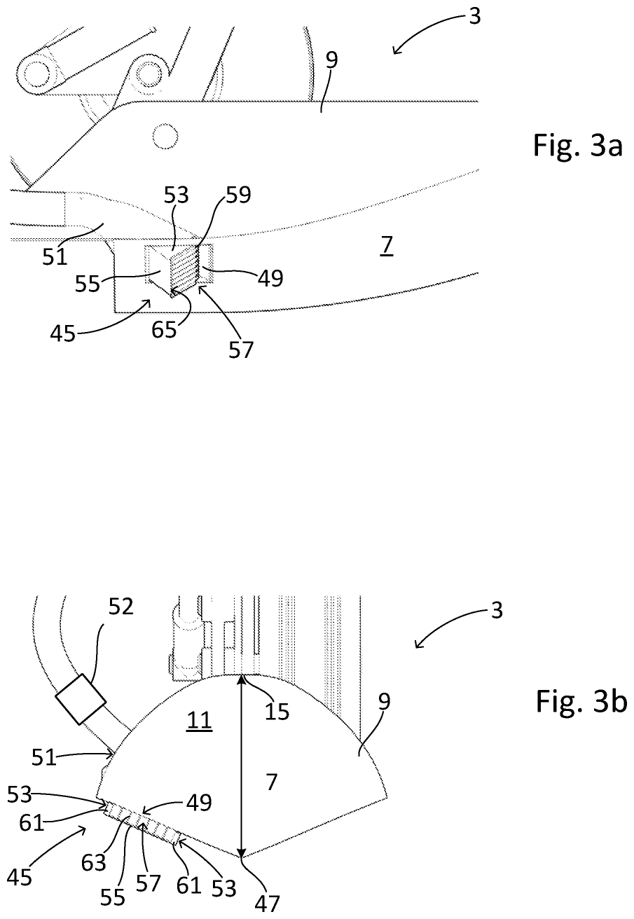

It may be briefly noted that the elongated body 9 depicted in FIGS. 2a and 2b further may comprise a hatch device 45, depicted to be positioned at the gliding surface 7 of the elongated body 9. This feature will be explained in more detail with reference to FIGS. 3a and 3b below.

FIGS. 3a-b show a close up of a hatch device 45 comprised in a surfing arrangement 3 in a side view and a front view respectively perspective views according to an embodiment. The side view depicted in FIG. 3a may be perceived as a close-up of the same arrangement as depicted in FIG. 2b, wherein FIG. 3b depicts the same arrangement, in the same lower position, as shown in FIG. 3a but seen from the front of the arrangement. FIG. 3b further shows the shape and design of the keel-shaped front portion 11, wherein it is visibly how the upwards directed and rounded front portion 11 provides a lip at the front tip 15 that protrudes high above a lowest point 47 of the gliding surface 7. This prevents water from easily splashing over the elongated body 9, but instead is naturally pushed down so as to flow underneath the elongated body 9 along the gliding surface 7.

Furthermore, as previously stated, the gliding surface 7 of the surfing arrangement 3 may further comprise a hatch device 45, which may be selectively movable between a closed state, in which it sits flush with the gliding surface 7, and an open state, in which an opening 49 is provided in the gliding surface 7. The hatch device 45 as depicted in FIGS. 3a and 3b is herein shown in its open state. The opening 49 provided in the gliding surface 7 may then be in fluid communication with a channel 51, which channel 51 is configured to be coupled to the water collecting system 10 of the aircraft 1. Such a coupling may, as depicted here, be achieved by means of a hose or tube or similar, which is to be perceived as being coupled to at least a tank 6 of a water collecting system 10, which tank may be positioned inside of the aircraft 1 or similar.

The hatch device 45 may of course be positioned at slightly different positions in or at the gliding surface 7 without deviating from the scope of protection as defined by the disclosure; however, there are several advantages of having it positioned as depicted in FIGS. 3a and 3b, or close to such a positioning. As is seen in these depictions, the hatch device 45 is arranged at a position in which water will naturally flow when the surfing arrangement 3 is used to surf on a surface of water. Water will be pushed to both sides of the gliding surface 7 under the elongated body 9, wherein the water being pushed towards the side comprising the hatch device 45 will flow towards the hatch device 45, wherein said water may flow inside of said hatch device 45 due to the pressure build-up between the gliding surface 7 and the water, combined with the speed of the aircraft 1.

The hatch device 45 may further comprise sidewalls 53 that extend from a hatch 55 of the hatch device 45 so as to cover sides areas of an open space 57 defined by the hatch 55 and the gliding surface 7 whenever the hatch device 45 is not in its closed state. Said sidewalls 53 will thus prevent water from flowing past the hatch 55, and it will instead be funnelled into said open space 57. By means of the angle of the hatch 55, the speed of the aircraft 1, and the sidewalls 53 of the hatch device 45, a very effective funnel is provided to the arrangement, which funnel guides the water being collected from the open space 57 into the opening 49 in the gliding surface 7. On the opposite side of the elongated body 9, relative the gliding surface 7, a channel 51 may be situated for further transportation of water pushed into the opening 49 in the gliding surface 7. The channel 51 may then lead said water into a tube, hose or pipe or similar, in which the water is pushed forwards therein by means of the pressure build-up between the gliding surface 7 and the body of water being surfed on. All these features combined provide parts of an extremely efficient water collecting system 10 that may be used to fill up a tank of such a system in a very short amount of time.

The hatch device 45 may be operational to be able to shift between its open state and its closed state in variety of ways, wherein such operations are used at will by means of a pilot flying the aircraft or a co-operator operating the system disclosed herein. The general concept is thus to fly down to a body of water, surf on its surface by means of the surfing arrangement 3, open the hatch device 45 so as to collect a certain amount of water in a water collecting system 10, close the hatch device 45 and then lift from the water and re-initiate regular flying. The collected water may then be dumped, at for example a forest fire, wherein the process may be repeated if desired. The hatch device 45 may be selectively operational by means of a hydraulic system, which may provide a controlled movement with the high forces producible with hydraulic machinery. The hydraulic system may be a hydraulic system also being used for control of vertical movement of the elongated body 9, or they may be controlled by separate hydraulic systems as well. A hydraulic cylinder having a piston therein may thus be used (not shown herein), wherein such a cylinder-piston used as an actuator for operating the hatch device 45 may be designed similarly to the hydraulic actuator described with reference to FIGS. 2a and 2b. Thus, a hydraulic cylinder-piston solution for operation of the hatch device 45 may be arranged in such a manner that the hatch device 45 is in its open state when the piston is at its maximum stroke. If the hydraulics of such a system would lose pressure, or experience a failure during a water collecting operation, the hatch device 45 will be biased to close instead of remaining open. This alleviates problematic situations such as the hatch device being open and dragging in the water when the pilot wants to perform a lift-off from the body of water.

The hatch device 45 may further be pivotally coupled to the gliding surface at a position 59 of the hatch device being closest to the front portion 11 of the elongated body 9. This means that the hatch 55 of the hatch device 45 is being pushed through the opening 49 in the gliding surface 7 when the hatch device 45 is being closed, and correspondingly being pivoted about the rotational axis of said pivoting coupling, from being positioned above the gliding surface 7 to extend downwards therefrom. By means of arranging a pivoting coupling in such a manner, it further enhances automatic closing of the hatch device 45 if a failure of some sort would occur in its operational mechanics.

An additional feature that may be provided to the hatch device 45, which feature is present in the depictions according to FIGS. 3a and 3b, is that the sidewalls 53 may further comprise flanges 61, arranged at edges of said sidewalls 53, said edges being situated flush with the gliding surface 7 when the hatch device 45 is in its closed state. This means that said flanges 61 then move from being flush with the gliding surface 7 towards being angled towards a flow of water adjacent the gliding surface 7 when the hatch device 45 is opened. This provides the hatch device 45 with a certain amount of force being applied to the flanges 61 when the water collecting system 10 is used, which force is applied to the flanges 61 by means of the water. Such forces are to be viewed as rather insignificant when compared to the forces of the aircraft 1 when propelled forward. However, such forces may be quite large when viewed as a means of closing the hatch device 45 if the mechanics of the opening/closing mechanisms would experience failure. Thus, such flanges 61 may act as a safety measure to avoid keeping the hatch device open 45 when not intended to be open.

The hatch device 45 may further, as depicted in FIGS. 3a and 3b, comprise a grating 63, extending from an inner surface 65 of the hatch 55, wherein said grating 63 is configured to cover the opening 49 in the gliding surface 7 when the hatch device 45 is in its open state. Such a grating 63 will not hinder water to enter the opening 49 in the gliding surface 7, and afterwards the water collecting system 10, in any significant way, but it does stop debris of different kinds to enter said water collecting system 10 in an efficient manner. Debris such as sticks and branches from trees or similar is not unusual to find floating in smaller bodies of water, wherein the grating 61 as defined herein alleviates the risk of getting such materials stuck in the initial opening 49 of the hatch device 45, and getting sucked into any downstream parts of a water collecting system 10. The opening 49 in the gliding surface 7 may further be provided with an additional second grating (not shown), which may extend fixedly and parallel with the gliding surface 7. The grating 63 of the hatch device and the second grating may then be configured to work in an integrated manner with each other so as to, when the hatch device 45 is closed, fill in the gaps of their respective gratings. In such a manner a sealed surface may be achieved by means of the two gratings overlapping each other when the hatch device 45 is in its closed state, and two gratings are provided to the initial inlet of the water collecting system 10 when the hatch device 45 is in its open state. This further alleviates the risk of debris of some sort getting into the water collecting system 10, without diminishing the water collecting capabilities of the arrangement and system in any critical way.

The opening in the gliding surface may be provided without the hatch device 45. The opening 49 may be in fluid communication with the channel 51 coupled to the water collecting system 10. A valve 52 arranged on or in the channel 51 may be controllable for opening and closing the communication between the opening 49 and the tank 6 (FIG. 1). During a water collecting operation, the valve 52 is open. After the water collecting operation has been finished, the valve 52 is closed in order to prevent water to flow out of the tank 6. However, the valve 52 may be opened during dumping the water for fire fighting a burning forest or similar.

A water collecting system 10 used in combination with the surfing arrangement 3 according to the disclosure herein may of course comprise additional components such as valves, pumps or other without deviating from the scope of protection for the surfing arrangement 3 as defined herein.

The foregoing description of the embodiments has been furnished for illustrative and descriptive purposes. It is not intended to be exhaustive, or to limit the embodiments to the variations described. Many modifications and variations will obviously be apparent to one skilled in the art. The embodiments have been chosen and described in order to best explicate principles and practical applications, and to thereby enable one skilled in the arts to understand the invention in terms of its various embodiments and with the various modifications that are applicable to its intended use. The components and features specified above may, within the framework of the disclosure, be combined between different embodiments specified.

1. A surfing arrangement for mounting to underneath an aircraft, comprising at least a tank of a water collecting system-, which arrangement is configured for providing a gliding surface on which said aircraft may surf on water when having a moving speed higher than a predetermined value and may sink in the water having a moving speed below the predetermined value, the arrangement comprises an elongated body having a front portion and a back portion and extending there between, underneath which elongated body the gliding surface is situated, wherein the elongated body is connectable to underneath an aircraft by means of a linkage arm arrangement arranged to a coupling element configured to be coupled to the aircraft, said linkage arm arrangement being, when the arrangement is coupled to an aircraft, operational to vertically move the elongated body between a raised position, in which raised position the gliding surface is positioned above a lowermost contact point of a piece of a landing gear, and a lower position, in which lower position the gliding surface is positioned underneath said lowermost contact point of the piece of said landing gear so as to perform a water collecting operation, said movement of the elongated body being selectively operational during flight of the aircraft.

2. The surfing arrangement according to claim 1, wherein the coupling element is configured to be coupled to the landing gear of an aircraft.

3. The surfing arrangement according to claim 1, wherein the front portion of the elongated body comprises a keel-shaped gliding surface-, and wherein the back portion of the elongated body comprises a ski-shaped gliding surface.

4. The surfing arrangement according to claim 1, wherein the linkage arm arrangement comprises a first and a second link arm members, pivotally coupled to the elongated body at a distance from each other at first end sections thereof, wherein the first link arm member is pivotally coupled to a fixed position of the coupling element, and the second link arm member is pivotally coupled to an actuator, which actuator is pivotally coupled to the coupling element.

5. The surfing arrangement according to claim 1, wherein the gliding surface further comprises a hatch device, selectively movable between a closed state, in which it sits flush with the gliding surface, and an open state, in which an opening is provided in the gliding surface, which opening is in fluid communication with a channel, which channel is configured to be coupled to the water collecting system of the aircraft.

6. The surfing arrangement according to claim 5, wherein the hatch device further comprises sidewalls that extend from a hatch of the hatch device so as to cover sides areas of an open space defined by the hatch and the gliding surface whenever the hatch device is not in its closed state.

7. The surfing arrangement according to claim 6, wherein the sidewalls further comprises flanges-, arranged at edges of said sidewalls, said edges being situated flush with the gliding surface when the hatch device is in its closed state.

8. The surfing arrangement according to claim 5, wherein the hatch device is pivotally coupled to the gliding surface at a position of the hatch device, which position is situated towards the front portion of the elongated body with respect to the hatch.

9. The surfing arrangement according to claim 5, wherein the hatch device further comprises a grating, extending from an inner surface of the hatch, wherein said grating is configured to cover the opening in the gliding surface when the hatch device is in its open state.

10. The surfing arrangement according claim 1, wherein the surfing arrangement further comprises a hydraulic system, wherein vertical movement of the elongated body is selectively operational by means of the hydraulic system.

11. The surfing arrangement according to claim 10, wherein the hatch device is selectively operational by means of the hydraulic system.

12. An aircraft comprising a body, wings, landing gear and at least a tank of a water collecting system, wherein the aircraft further comprises at least one surfing arrangement according to claim 1, which surfing arrangement is coupled to underneath said aircraft.
